(19) United States
(12) Patent Application Publication
(10) Pub. No.: US 2008/0040262 A1
(43) Pub. Date: Feb. 14, 2008

(54) Voice authenticated financial transaction

(75) Inventors: Subramanian D K, Bangalore (IN); Sridhar K, Bangalore (IN); Rishi K, Bangalore (IN); Mahesh Kumar Jain, Bangalore (IN); Mahendra Pratap, Bangalore (IN)

Correspondence Address: Ashok Tankha,;Lipton, Weinberger & Husick, 36 Greenleigh Drive, Sewell, NJ, 08080, US

(73) Assignee: Integra Micro Systems (P) Ltd, Bangalore (IN)

(21) Appl. No.: 11/801,366

(22) Filed: May 9, 2007

(30) Foreign Application Priority Data
Aug. 10, 2006 (IN) 1428/CHE/2006

(51) Int. Cl. G06Q 40/00; G06F 3/01; H04L 9/00; G06F 3/16

(52) U.S. Cl. 705/39; 235/3; 340/5.81; 340/5.82; 715/700

(57) ABSTRACT

The method and system disclosed herein provides a method and system for enabling users to conduct financial transactions with voice enabled merchant devices. The overall system comprises of a merchant device operated by the merchant, electronic handheld devices operated by users, i.e. customers, and a banking server that is in communication with the merchant device. The merchant device guides the user in conducting financial transactions. The merchant device comprises of a radio frequency identification (RFID) unit, a biometric identification unit and a voice module. The RFID module identifies the unique radio frequency identifier of the user, and for receiving and transmitting information via radio frequency. The biometric identification unit is used for capturing and authenticating the identity of individuals and authorizing transactions. The voice module provides a voice response back to the user, requesting a confirmation via biometric authentication in order to complete a transaction after the user initiates a financial transaction.

### BACKGROUND OF THE INVENTION

This invention in general relates to a method and system of conducting transactions and in particular to conducting authenticated financial transactions using handheld devices with radio frequency identification and biometric authentication, and merchant devices that guide the user in a voice mode.

The applications of electronic financial transaction devices, such as devices located at a merchant that accept credit cards, debit cards or smart cards, are rapidly growing in both the urban and rural segments of the society.

The operating procedures of financial transaction devices are becoming increasingly complicated, especially for users who are not technologically conversant or those who are uneducated or ill equipped to interact with such devices.

If a user takes an abnormally long time for an input operation during a transaction, a forced time-out could take place. In the process of interacting with a financial transaction device, an uneducated person might unknowingly issue a wrong command and conduct an undesired financial transaction.

It is critical that details of a transaction are confirmed via an authenticated response prior to completing a transaction, especially for users who might not necessarily be educated enough to read and write or who might forget the authentication PIN code.

There is a need for a method and system that does not permit middlemen to fraudulently conduct financial transactions on behalf of an uneducated user. Also it is essential that a financial transaction be permitted on the card only on successful authentication of the true owner of the card.

### SUMMARY OF THE INVENTION

The method and system disclosed herein addresses the above challenges and enables even uneducated users to securely conduct financial transactions with voice enabled merchant devices; eliminates the possibility of incorrect transactions; and eliminates fraudulent transactions performed without the knowledge of the user.

The system disclosed herein comprises of a merchant device operated by the merchant, an electronic handheld device operated by the user, i.e. customer, and a banking server that is in communication with the merchant device. The merchant device guides the user in conducting financial transactions. The merchant device comprises of a radio frequency identification unit (RFID), biometric identification unit, a voice module, a merchant communication module, a user interface, a printer, and an application-processing module. A radio frequency identification module within the merchant device identifies the unique identity of the user's electronic handheld device. The biometric identification unit is used for authenticating the identity of individuals and authorizing transactions. After the user initiates a financial transaction, the voice module provides a voice response back to the user in the user's preferred language, requesting confirmation via biometric authentication in order to complete the transaction. Each electronic handheld device operated by the user is allocated a unique identifier. The electronic handheld device comprises of a radio frequency module with an embedded unique identifier, a memory module, and a financial module. The radio frequency module of the electronic handheld device provides the unique identifier to the individual user, and also serves as means of communication with the merchant device. The memory module stores the biometric and other user related information of the user. The financial module maintains cash balance and the transaction history of the user. The banking server stores the biometric identity and unique radio frequency identity of the users. The merchant device is in communication with the banking server through a wireless or wire line network.

It is an object of the invention to enable users operating the electronic handheld devices to conduct financial transactions with voice enabled merchant devices that respond in the language of a user to confirm a requested transaction.

It is another object of the invention to use biometric templates and radio frequency identification module at the merchant device for authentication of the financial transaction. Every transaction can be biometrically authenticated.

It is another object of the invention to enable a merchant device to interact with users in a plurality of languages.

### BRIEF DESCRIPTION OF THE DIAGRAMS

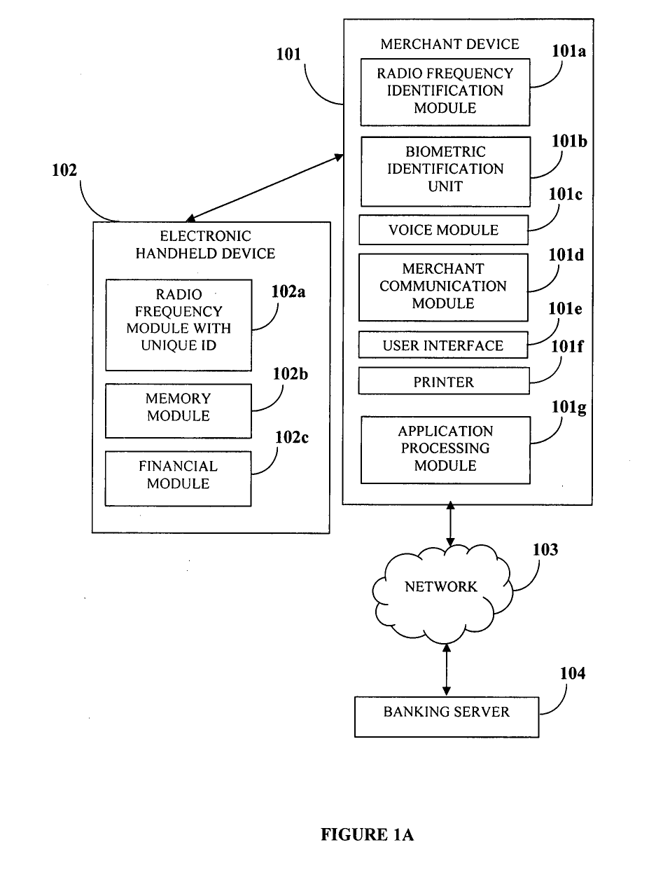

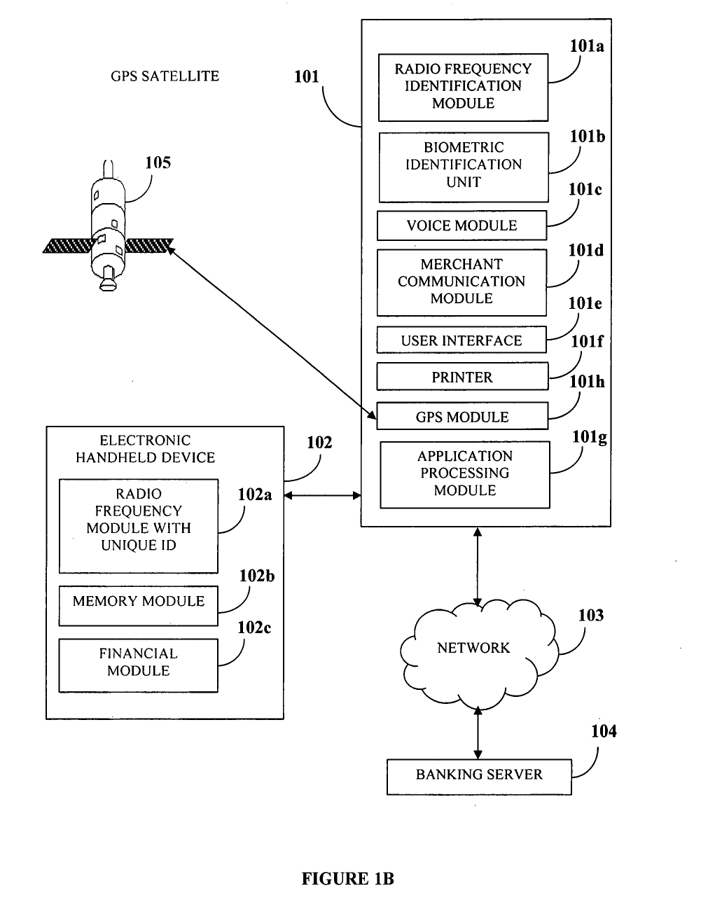

FIG. 1A illustrates a system that enables users to conduct financial transactions with voice enabled merchant devices.

FIG. 1B illustrates, a system that enables users to conduct financial transactions with voice enabled merchant devices, in conjunction with a global positioning system (GPS).

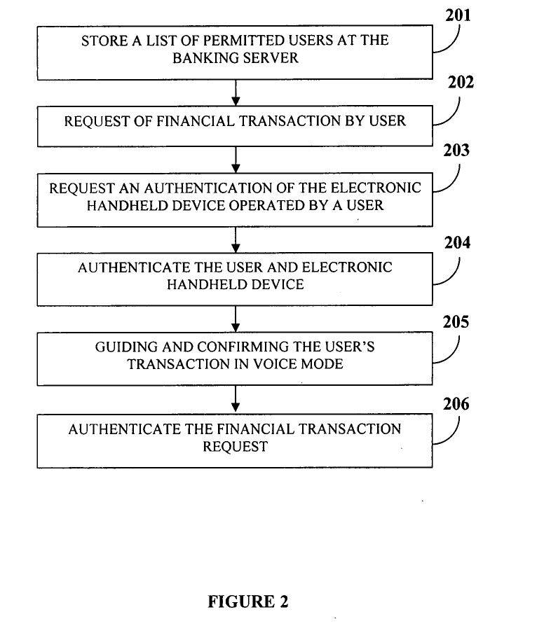

FIG. 2 illustrates a method for enabling the users operating electronic handheld devices to conduct financial transactions with voice enabled merchant devices.

### DETAILED DESCRIPTION OF THE DIAGRAMS

FIG. 1A illustrates a system of one embodiment of the invention that enables users to conduct financial transactions with voice enabled merchant devices. FIG. 1B illustrates a system of another embodiment of the invention that enables users to conduct financial transactions with voice enabled merchant devices, in conjunction with a global positioning system (GPS).

The merchant device 101 consists of a radio frequency identification module 101a, a biometric identification unit 101b, a voice module 101c, a merchant communication module 101d, user interface 101e, a printer 101f, and an application-processing module 101g. The user conducts financial transactions with the merchant device 101 using an electronic handheld device 102. The electronic handheld device 102 comprises of a radio frequency module with an embedded unique identifier (RFID) 102a, a memory module 102b and a financial module 102c. The user interacts with the merchant device 101 using the electronic handheld device 102 for effectively carrying out financial transactions. The voice module 101c guides the user in carrying out the financial transactions. The voice module 101c provides a voice response back to the user, requesting a confirmatory biometric authentication for the financial transaction initiated by the user. The banking server 104 stores a list of users and their respective unique radio frequency identifiers and biometric templates and the financial data. The merchant device 101 communicates with the banking server 104 via a wireless or a wire line network. The financial transaction request is successfully authenticated only if the live biometric identifier of the user transmitted by the electronic handheld device 102 matches with a permitted biometric template located in the banking server 104.

Optionally, the electronic handheld device 102 also contains a photograph of the permitted user. The merchant uses the photograph as a first level of verification prior to requesting further authentication of the user via biometrics.

The radio frequency module 102a provides a unique identifier to the individual user and also serves as a means of communicating with the merchant device 101.

Optionally, the electronic handheld device 102 comprises a biometric identification unit 101b. The biometric identification unit 101b contains a biometric receptacle. In one embodiment of the invention, the biometric receptacle captures the user's biometric profile, for example, a fingerprint, and compares the live captured biometric profile with a pre-stored original biometric template stored in the electronic handheld device 102 during registration. In another embodiment of the invention, the biometric receptacle captures the user's biometric profile and the live captured biometric profile is compared with a pre-stored original biometric template stored in the banking server 104.

In one embodiment of the invention, the radio frequency identification is a contact less data exchange technology that uses compact electronic tags also known as transponders to store information, and a wireless radio frequency (RF) reader to capture the information. The system of this invention can use either active or passive RFID transponders. The active RFID transponder has its own power supply. In contrast, a “passive” transponder does not have power supply of its own, and is energized by an RF signal from the reader when placed in close proximity to the reader.

In the case of contact less data exchange, the electronic handheld device 102 communicates with the merchant device in one radio frequency range. The merchant device 101 communicates with the banking server 104 on another frequency over wireless or wire line media.

In another embodiment of the invention, the connection between the electronic handheld device 102 and the merchant device 101 is contact based, for example the electronic handheld device 102 is placed in a slot within the merchant device 101 during the transaction process.

The memory module 102b of the electronic handheld device 102 is used for storing the biometric identity and other user related information of the unique user of the electronic handheld device 102. To conduct a transaction, the user brings the electronic handheld device 102 closer to the merchant device 101. When the user requests a financial transaction with the merchant device 101, the radio frequency module 102a transmits the unique identifier; and the biometric and other user related information stored in the memory module 102b; to the merchant device 101. The memory module 102b also may store the language preferences of the unique user of the electronic handheld device 102.

The financial module 102c of the electronic handheld device 102 maintains the updated cash balance and the financial transaction history of the user as defined by the application.

The radio frequency identifier module 101a of the merchant device 101 identifies the received unique radio frequency identifier of the radio frequency module 102a. The identification is performed by comparing the unique radio frequency identifier of the radio frequency module 102a stored in the banking server 104 to the currently received unique radio frequency identifier of the radio frequency module 102a.

The biometric identification unit 101b of the merchant device 101 enables the authentication of the identity of the individuals and authorization of the financial transactions. Biometric identification is carried out by capturing the physiological and behavioral characteristics of the user, for example, face shape, fingerprints, voice etc. A biometric template of the user is captured during the enrollment process and stored in the banking server 104. The user of the electronic handheld device 102 makes a claim of identity. The merchant device 101 authenticates the identity claim by comparing the live biometric data of the user made during the financial transaction to the biometric template of the user stored in the banking server 104. The purpose of the biometric authentication of the identity is to prevent the usage of the handheld electronic device 102 by any user other than the one to whom it is issued to.

The voice module 101c of the merchant device 101 comprises of a voice synthesizer that allows the merchant device 101 to generate a speech output. Optionally, the merchant device 101 provides a list of languages on its display screen from which the user can select a language for communicating with the merchant device 101. If the authentication of the identity of the electronic handheld device 102 in the proximity of the merchant device 101 is successful, the voice module 101c of the merchant device 101, in voice mode, requests the user to confirm the transaction by providing a live biometric identifier. The user provides a live biometric identifier, for example, by placing his finger on the merchant device 101. The merchant device 101 again authenticates the identity claim by comparing the live biometric data of the user made during the financial transaction to the biometric template of the user stored in the banking server 104. If the authentication is successful, the merchant device 101 executes the financial transaction initiated by the user.

The voice module 101c comprises of a speech synthesizer that can be implemented in either software or hardware. The text-to-speech (TTS) system has both of the following characteristics: naturalness and intelligibility. As the TTS application of this invention is applied to a plurality of customers in a certain geographical region, potentially with a plurality of dialects of the same language within a larger region, the “naturalness” feature of the output of the TTS as well as intelligibility are critical success factors. The text-to-speech system consists of a reception module, processing module, and a synthesizer. The reception module receives text input, the processing module identifies a symbolic linguistic representation of the input text and the synthesizer outputs the synthesized speech waveform.

The reception module performs text normalization, wherein it accepts text inputs and may determine their written-out word equivalents. The processing module assigns phonetic transcriptions to each word, and divides and marks the text into various units, like phrases, clauses, and sentences. The phonetic transcriptions and prosody information, depending on the language or its particular dialect, determines the symbolic linguistic representation. The symbolic linguistic representation is inputted to the synthesizer and the synthesizer then converts it into a sound output.

The voice module 101c guides the user in the transaction process. It primarily dictates the summary of the financial transaction, for example, it would dictate “this costs Rs. 50, if you are willing to pay for this, please authenticate by placing your finger on the merchant device”. In the primary embodiment of the invention, the synthesizer concatenates pre-recorded words and phrases to create complete utterances. These words and phrases are pre-recorded in the language or dialect of the region in which the merchant device is used. For example, India has about 22 languages and 1500 dialects, it is essential that the synthesizer generates the natural tone of the regional language.

The merchant communication module 101d of the merchant device 101 provides the channel for communication between the electronic handheld device 102 of the user and the banking server 104. The user interface 101e assists the user to interact with the application comprising of electronic handheld device 102, merchant device 101 and the banking server 104. The printer 101f residing in the merchant device 101 provides receipt as the proof of the financial transaction between the user and the system comprising of the electronic handheld device 102, merchant device 101 and banking server 104. GPS module 101h determines the position of the merchant device 101. The application processing module 101g co-ordinates the activities of all the other modules and also assists in computing stored functions.

In another embodiment of the invention, the owner of the merchant device 101, i.e. the merchant is required to authenticate herself prior to executing a transaction. This ensures that only the genuine merchant is permitted to transact using the merchant device 101 with the banking server 104 and thereby avoids fraudulent use of the merchant device 101. The biometric identification unit 101b of the merchant device 101 enables the verification of the identity of the merchant. Biometric identification is carried out by capturing the physiological and behavioral characteristics of the user, for example, face shape, fingerprints, voice etc. A biometric template of the merchant is captured during the enrollment process and stored in the merchant device 101 and banking server 104. The user of the merchant device 101 makes a claim of identity by providing their live biometric feature. The merchant device 101 contains a means of accepting the live biometric feature, for example, the merchant device can include a finger print scanner that captures the fingerprint of the merchant. The merchant device 101 authenticates the identity claim by comparing the captured live biometric data to the biometric template stored during enrollment in the merchant device 101 and in the banking server 104. If the authentication is successful, the merchant device 101 permits the merchant to use the merchant device 101 for conducting financial transactions. The merchant is required to authenticate in this manner prior to conducting every new financial transaction.

The merchant device 101 and the banking server 104 communicate via a wireless or wire line network 103. This method and system disclosed herein is operable on a variety of mobile networks including advanced mobile phone service (AMPS), code division multiple access (CDMA), global system for mobile communications (GSM), digital cellular telephone system, general packet radio service (GPRS), time division multiple access, (TDMA) digital cellular telephone system or public network such as the as the internet or public switched telephone network (PSTN) or local area network or the wide area network or worldwide interoperability for microwave access Worldwide Interoperability for Microwave Access (WiMAX) and WiFi.

The banking server 104 stores a list of users with their respective user profiles, unique identifiers, biometric templates and financial and other relevant data. The banking server 104 is in communication with the merchant device 101 via the network 103.

In another embodiment of the invention, the GPS module 101h within the merchant device 101 determines the position of the merchant device 101 via the GPS satellite 105 and thereafter determines the local language that is associated with that particular geography. In this case, the voice response from the merchant device 101 is in the local language.

FIG. 2 illustrates a method for enabling the users operating electronic handheld devices to conduct financial transactions with voice enabled merchant devices. The banking server 104 stores a list of permitted users with their respective unique identifiers and biometric templates 201. The user initiates a financial transaction 202. The merchant device 101 requests for the authentication of the electronic handheld device 102 operated by the user in the proximity of the merchant transaction device 203. The authentication of the electronic handheld device 102 is successful only if the radio frequency identifier received from the electronic handheld device 102 at the merchant device 101 is one of the permitted identifiers in the stored list of permitted users 204 at the banking server 104. The merchant device 101 guides and confirms the user's transaction in the voice mode 205. The merchant device 101 successfully authenticates the financial transaction request if the live biometric identifier matches with a permitted biometric template stored in the banking server 104, 206.

In the primary embodiment of the invention, authentication of the user is performed with the electronic handheld device 102 in communication with the banking server 104. The true biometric feature of the user is captured during enrollment and stored in the banking server 104. When a user is required to authenticate, the live biometric feature captured by the electronic handheld device 102 is compared with the stored biometric template in the banking server 104.

In a secondary embodiment of the invention, authentication of the user is performed within the electronic handheld device 102. In this case, the true biometric feature of the user is captured during enrollment and stored in the electronic handheld device 102. When a user is required to authenticate, the live biometric feature captured by the electronic handheld device 102 is compared with the stored biometric template.

In the primary embodiment of the invention, authentication of the merchant is performed with the merchant device 101 in communication with the banking server 104. The true biometric feature of the merchant is captured during enrollment and stored in the banking server 104. When a merchant is required to authenticate, the live biometric feature captured by merchant device 101 is compared with the stored biometric template in the banking server 104.

In a secondary embodiment of the invention, authentication of the merchant is performed within the merchant device 101. In this case, the true biometric feature of the user is captured during enrollment and stored in the merchant device 101. When a merchant is required to authenticate, the live biometric feature captured by the merchant device 101 is compared with the stored biometric template.

In the primary embodiment of the invention, the transaction is permitted only when the merchant device 101 is online, i.e. the merchant device 101 is in communication with the banking server 104 via the network 103.

In the secondary embodiment of the invention, the transaction is permitted even when the merchant device 101 is offline, i.e. the merchant device 101 is not necessarily in communication with the banking server 104 via the network 103. A transaction limit can be predetermined and established for performing transaction without connectivity with the banking server 104. Similarly, a transaction limit can be established for situations where the network 103 is available i.e. online transactions.

The following example illustrates the primary embodiment of the invention, wherein connectivity with the banking server is essential for conducting a transaction. Consider a user Ms. Usha who wants to purchase a bag of rice at a grocery store. Usha displays her electronic handheld device, i.e. her card, in front of the merchant device 205 located in the Grocery store. The RFID identifier of Usha stored in her card is transmitted via radio frequency to the merchant device, i.e. the device for conducting transactions at the grocery store. The merchant device then communicates via a GSM wireless network to a banking server. The radio frequency identifier of Usha was stored in the banking server during the process of Usha's enrollment and issuance of the electronic handheld device. The stored radio frequency identifier of Usha's card is compared with the radio frequency identifier stored in the banking server. If there is a match, then the merchant device is ready to transact. The grocery store manager then inputs the sale information, i.e. the bag of rice and its price and other information. Next, the merchant device speaks out the details of the transaction as follows “Usha, do you confirm purchase of a bag of rice at Rs. 5/kilogram, place your finger on your card to confirm the order”. Usha then places her finger on a specific portion of her card. Usha's live fingerprint is then transmitted via radio frequency from her card to the merchant device. The merchant device then compares this live fingerprint with the stored fingerprint of Usha in the baking server. This comparison is made in the banking server. If there is a match in fingerprints, the merchant device executes the transaction, debits Usha's card and Usha's bank account of Rs. 50 and the merchant hands over the bag of rice to Usha along with a receipt of the transaction. In another embodiment of the invention, the GPS unit within the merchant device determines the position of the merchant device and thereafter determines the local language that is associated with that particular geography. In this case, the voice response from the merchant device is in the local language. This embodiment of the invention is particularly useful in countries with a large number of regional languages or dialects such as in India and China.

The following example illustrates the secondary embodiment of the invention, wherein authentication of a transaction in the electronic handheld device or the merchant device does not require connectivity to the banking server. Consider a user Ms. Usha who wants to purchase a bag of rice at a grocery store. Usha displays her electronic handheld device 102, i.e. her card, in front of the merchant device 205 operated by merchant Mr. George located in the Grocery store. The RFID identifier of Usha stored in her card is transmitted via radio frequency to the merchant device, i.e. the device for conducting transactions at the grocery store. The merchant device then requests Usha to authenticate herself using her electronic handheld device. Usha, places her finger on the biometric receptacle on her electronic handheld device. The biometric receptacle captures her fingerprint and compares the live captured fingerprint with a pre-stored original fingerprint of Usha stored in the electronic handheld device during registration. If there is a match, then Usha is allowed to transact using the electronic handheld device. In a similar manner, the merchant George authorizes himself with the merchant device using biometric authentication. The merchant George then inputs the sale information, i.e. the bag of rice and its price and other information. The merchant George then asks Usha her language of choice, or displays the available languages of choice on the merchant device. Usha selects her language of choice, following which, the merchant device speaks out the details of the transaction in Usha's language of choice as follows “Usha, do you confirm purchase of a bag of rice at Rs. 5/kilogram, place your finger on your card to confirm the order”. Usha, then again authenticates via biometric authentication using her electronic handheld device, in the same manner described earlier in this paragraph. If the authentication is successful, the merchant device executes the transaction, debits Usha's card of Rs. 50 and the merchant hands over the bag of rice to Usha along with a receipt of the transaction. In another embodiment of the invention, the GPS unit within the merchant device determines the position of the merchant device and thereafter determines the local language that is associated with that particular geography. In this case, the voice response from the merchant device is in the local regional language. In this second embodiment, the electronic handheld device and the merchant device work offline, i.e. they are not connected to the server. At a future point in time, when connectivity is established between the banking server and the electronic handheld device or the merchant device, the information on the executed transaction is updated in the banking server.

The foregoing examples have been provided merely for the purpose of explanation and are in no way to be construed as limiting of the present method and system disclosed herein. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

1. A system for enabling users to conduct financial transactions with voice enabled merchant devices, comprising:
a merchant device operated by the merchant, that guides the user in conducting financial transactions, further comprising;
a radio frequency identification module for identifying the unique identifier of the user, and for receiving and transmitting information via radio frequency;
a biometric identification unit for authenticating the identity of individuals and authorizing transactions;
a voice module that guides said user, and responds to a request for conducting a transaction by the user in the language of the user by providing a voice response back to the user, requesting authentication for said transaction;
an electronic handheld device operated by the user, that has a unique identifier for each user, further comprising;
a radio frequency identification unit for providing unique identifiers to individuals and for communicating with said merchant device;
a memory module that stores the biometric information of said unique user;
a financial module that maintains the cash balance and transaction history information; and
a banking server that is in communication with said merchant transaction device via a network, wherein the merchant device credits, debits and conducts other financial transactions via said banking server.

2. The system of claim 1, wherein said electronic handheld device can be a standard cellular phone, smart phone, personal digital assistant, a satellite phone or a radio frequency identification card or a smart card.

3. The system of claim 1, wherein said biometric identification unit may recognize any one of the following biometric features; fingerprint, speech, face, voice, retina, iris, handwritten signature, hand geometry or veins.

4. The system of claim 1, wherein said voice module comprises a means for selecting a language for communication with the user.

5. The system of claim 1, wherein the financial module maintains the transaction history of the user, the credited amount and the remaining balance amount in the user's account.

6. The system of claim 1 wherein the banking server comprises a database that stores the biometric templates, user profile, the language preference and the unique identifier of the users.

7. The system of claim 1, wherein the network is one or more of the following, a wire line, wireless, global system for mobile communications, code division multiple access, advanced mobile phone service, digital cellular telephone system, general packet radio service, time division multiple access, digital cellular telephone system, universal mobile telecommunications system, satellite communication network, or public network which can be public switched telephone network, local area network, wide area network, worldwide interoperability for microwave access or the internet.

8. The system of claim 6, where the user profile comprises of the name of the user, the demographic profile of the user and the language preferences of the user.

9. The system of claim 1, wherein the merchant device further comprises a user interface that can display language transaction options, results and language options to the user, and can display the transaction results.

10. The system of claim 1, wherein the merchant device further comprises a printer device that physically prints out a receipt of the results of a transaction.

11. A method for enabling users operating electronic handheld devices to conduct financial transactions with a voice enabled a merchant device that is in communication with a banking server via a network, the method comprising the steps of:
providing a list of permitted users by storing their respective unique radio frequency identifiers and biometric templates in said banking server;
requesting a financial transaction by said user with said merchant;
requesting an authentication of the electronic handheld device operated by a user at the merchant transaction device,
successfully authenticating the electronic handheld device only if the radio frequency identifier received from the electronic handheld device at the merchant device is one of the permitted identifiers in said provided list of permitted users;
guiding and confirming the user's transaction in voice mode; and
successfully authenticating said financial transaction request if live biometric identifier matches with a permitted biometric template located in the banking server.
